(19) United States
(12) Patent Application Publication
(10) Pub. No.: US 2002/0033632 A1
(43) Pub. Date: Mar. 21, 2002

(54) Child car seat for a vehicle

(76) Inventors: William R. Gibson, Kent, OH (US); Enrique R. Giner, Streetsboro, OH (US); Maria A. Giner, Streetsboro, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 09/843,959

(22) Filed: Apr. 27, 2001

Related U.S. Application Data
(60) Provisional application No. 60/232,817, filed on Sep. 15, 2000.

(51) Int. Cl. B60N 2/28

(52) U.S. Cl. 297/483

(57) ABSTRACT

A child car seat for a vehicle. The vehicle has a shoulder belt, and the shoulder belt includes a webbing. The child car seat includes a structural seat back and a vehicle-shoulder-belt-receiving first hook attached to the seat back. The first hook substantially encloses a first through slot, wherein the first through slot extends from front to back. The first hook includes two hook members which are spaced apart from each other by a first gap which is larger than the thickness of the webbing. The webbing is engageable in the first through slot.

### CROSS REFERENCE TO RELATED APPLICATIONS

The present application claims priority of U.S. Provisional Application No. 60/232,817 filed Sep. 15, 2000, the entire disclosure of which is incorporated herein by reference.

### BACKGROUND OF THE INVENTION

The present invention relates generally to child car seats for vehicles, and more particularly to a child car seat for use with a shoulder belt of a vehicle.

Conventional child car seats include those which are removably installed in a vehicle by use of the vehicle's seat belts, such as by use of the vehicle's lap belts or by use of the vehicle's lap and shoulder belts. The child is secured in the installed seat by use of separate harness belts attached to the car seat or by use of the same vehicle seat belts being used to install the car seat in the vehicle. It is noted that child car seats are not limited to cars but can be used in any vehicle having vehicle seat belts. It is further noted that a child car seat designed or used without separate harness belts is sometimes referred to as a child booster seat.

A known child car seat makes use of the vehicle's lap belt and shoulder belt both to secure the car seat to the vehicle and to secure the child in the car seat. The lap belt goes transversely across the seat bottom, and the shoulder belt goes diagonally across the seat back. Typically, the seat bottom and the seat back define a monolithic structure which consists essentially of plastic. In one known design, the seat back is a wing back having first and second side portions. A cushion pad covers the seat bottom and the wing back to provide comfort for the child. There may be a separate cushion pad for the seat bottom and a separate cushion pad for the seat back (e.g., a wing back). Plastic hooks are sewn at different heights to each side of the cushion pad near the shoulder level of a varying-height-range of children. Each substantially-enclosed hook retains and positions the shoulder belt thus both securing the child to the wing back and securing the wing back to the vehicle. The shoulder belt is retained and positioned in a hook of proper height for the particular child. Higher height hooks are used as the child grows. Each hook has a small slit which is just wide enough to receive the webbing of the shoulder belt edgewise (i.e., a little larger than the thickness of the webbing of the shoulder belt). By having hooks on each side of the cushion pad, the car seat can accommodate a vehicle shoulder belt coming form the right or the left of the car seat.

Another known child car seat utilizes a plastic, multi-hook assembly riveted or screwed to the side of the wing back, wherein each hook has a small slit which is just wide enough to receive the webbing of the shoulder belt edgewise, and wherein each hook substantially encloses a sideways-extending through slot for accepting and positioning the webbing.

What is needed is a child car seat which better accommodates the shoulder belt of a vehicle.

### SUMMARY OF THE INVENTION

A first expression of a preferred embodiment of the invention is for a child car seat for a vehicle, wherein the vehicle has a shoulder belt, and wherein the shoulder belt includes a webbing. The child car seat includes a structural seat back and includes a vehicle-shoulder-belt-receiving first hook attached to the seat back. The first hook substantially encloses a first through slot, wherein the first through slot extends substantially from front to back, wherein the first hook includes two hook members which are spaced apart from each other by a first gap, wherein the first gap is larger than the thickness of the webbing, and wherein the webbing is engageable in the first through slot. Preferably, the seat back and the first hook define a monolithic structure. Preferably, the child car seat also includes a second hook attached to the seat back below the first hook.

A second expression of a preferred embodiment of the invention is for a child car seat for a vehicle, wherein the vehicle has a shoulder belt, and wherein the shoulder belt includes a webbing. The child car seat includes a structural seat back, a first hook member, and a second hook member. The seat back includes a wing back having opposing first and second side portions each having an outside surface facing substantially away from each other and each having an inside surface facing substantially toward each other. The first hook member has a first attached portion rigidly attached to the first side portion and has a first spaced-apart portion spaced apart from the outside surface of the first side portion. The second hook member is spaced apart from the first hook member, has a second attached portion rigidly attached to the first side portion, and has a second spaced-apart portion spaced apart from the outside surface of the first side portion. The first and second spaced-apart portions are spaced apart from each other by a first gap which is larger than the thickness of the webbing and which is smaller than the width of the webbing. The first and second attached portions are spaced apart from each other by a separation distance which is larger than the first gap. The first hook member and the second attached and spaced-apart portions of the second hook member together define a sideways-projecting and shoulder-belt-receiving first hook substantially enclosing a first through slot extending substantially from front to back. The webbing is engageable in the first through slot.

Several benefits and advantages are derived from the invention. The design of the child car seat of the invention allows the vehicle shoulder belt to be positioned and retained in a hook which is attached to the seat back providing a more secure attachment than those prior art designs which attach the hook to the cushion pad. The design of the child car seat of the invention provides a hook substantially enclosing a through slot extending substantially from front to back which provides a shorter and more natural path for the webbing than do those prior art hook designs which have slots providing a sideways path for the webbing. The front-to-back slot of the invention allows the webbing to more naturally bend over the child's body instead of having the webbing being bent by the hook as is the case with the sideways slot design of the prior art. Having the hook and the seat back define a monolithic structure reduces manufacturing time and costs.. It is noted that the cushion pad would be cut to surround the hook as it protrudes from the seat back (e.g., wing back). It is further noted that the child car seat of the invention allows for multiple hooks so that the vehicle shoulder belt can be correctly positioned as the child grows.

### BRIEF DESCRIPTION OF THE DRAWINGS

FIG. 1 is a schematic, perspective view of a preferred car seat of the invention;

FIG. 2 is a front elevational view of the car seat of FIG. 1 together with a portion of a vehicle including a portion of a vehicle shoulder belt;

FIG. 3 is a front elevational view of the car seat of FIG. 1; and

FIG. 4 is a side elevational view of the car seat of FIG. 1.

### DETAILED DESCRIPTION

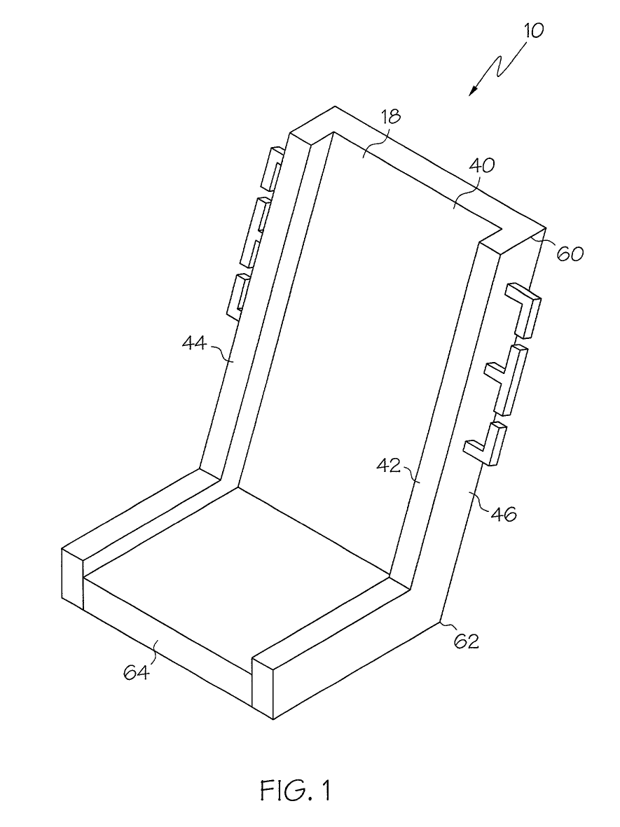

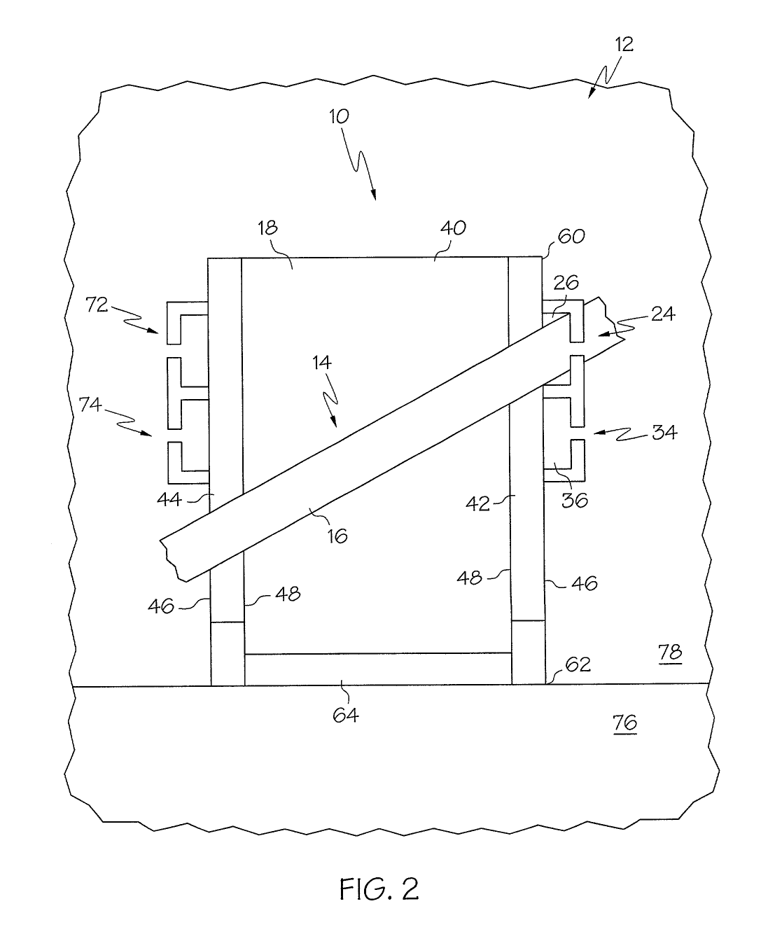

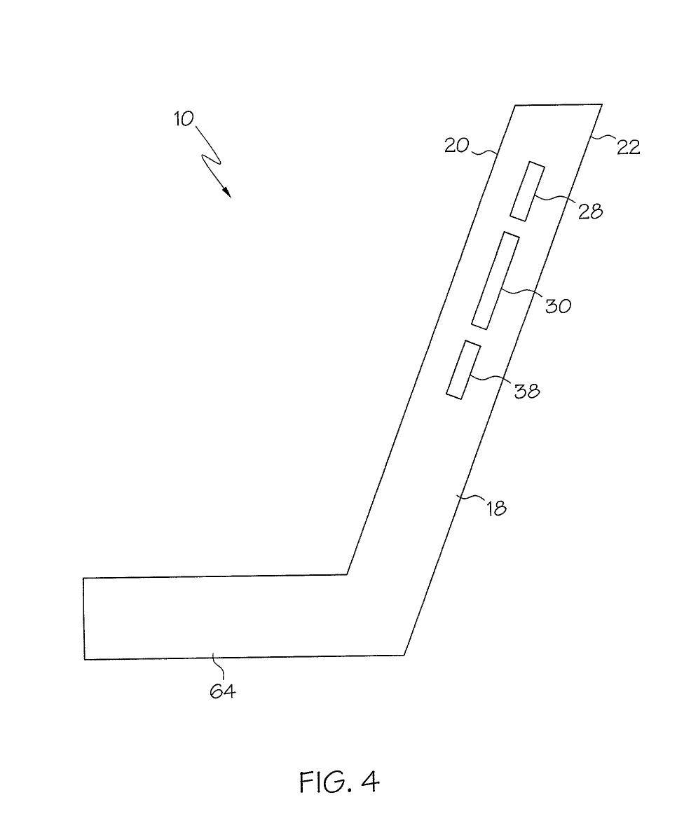

A preferred embodiment of the invention is for a child car seat 10 and is shown in FIGS. 1-4 (not drawn to scale) with the cushion pad removed for clarity as the cushion pad of the child car seat 10 does not constitute a part of the invention. The terminology “child car seat” includes child car seats having a separate child harness to secure the child in the child car seat, child car seats which use the vehicle lap and shoulder belts both to secure the child in the child car seat and to secure the child car seat to the vehicle (sometimes called child booster seats because they raise a child to a proper seating height for the vehicle shoulder belts), and child car seats which can be used with a separate child harness when the child is younger and which can be used without a separate child harness when the child is older. The child car seat 10 is for a vehicle 12, only a portion of which is shown (of a vehicle seat and of a vehicle shoulder belt) together with the child car seat 10 in FIG. 2. It is noted that the child car seat 10 is not limited for use with cars but can be used in any vehicle 12 (including, without limitation, cars, trucks, boats, planes, and trains), wherein the vehicle 12 has, as shown in FIG. 2, a shoulder belt 14, and wherein the shoulder belt 14 includes a webbing 16 (i.e., a belt portion as opposed to a buckle portion or a vehicle attachment portion of a vehicle shoulder belt). It is noted that the webbing 16 has a length (only a portion of which is seen in FIG. 2), a width (seen in FIG. 2), and a thickness.

In a first expression of the preferred embodiment of the invention shown in the figures, the child car seat 10 includes a structural seat back 18 having a front 20 and a back 22 and includes a shoulder-belt-receiving first hook 24 attached to the seat back 18. It is noted that “attached” includes monolithically, directly, or indirectly attached. The first hook 24 substantially encloses a first through slot 26, wherein the first through slot 26 extends substantially from front to back. The first hook 24 includes two hook members 28 and 30 which are spaced apart from each other by a first gap 32, wherein the first gap 32 is larger than the thickness of the webbing 16, and wherein the webbing 16 is engageable in the first through slot 26.

Preferably, the first gap 32 is smaller than the width of the webbing 16. In one construction, the seat back 18 and the first hook 24 together define a monolithic structure. In one choice of materials, the monolithic structure comprises (and preferably consists essentially of, and more preferably consists of) plastic, such as polypropylene.

In one example, the child car seat 10 also includes a vehicle-shoulder-belt-receiving second hook 34 attached to the seat back 18 below the first hook 24. The second hook 34 substantially encloses a second through slot 36, wherein the second through slot 36 extends substantially from front to back. The second hook 34 includes two hook members 30 and 38 which are spaced apart from each other by a second gap, wherein the second gap is larger than the thickness of the webbing 16.

Preferably, the first and second gaps each are smaller than the width of the webbing. In one construction, the seat back 18, the first hook 24, and the second hook 34 together define a monolithic structure. In one choice of materials, the monolithic structure comprises (and preferably consists essentially of, and more preferably consists of) plastic, such as polypropylene. In another construction, not shown in the figures, the first hook would have a base rigidly attached to the seat back 18, wherein the previously described first and second hook members would be attached to the base in any structural manner such as, without limitation, by a swivel, a hinge, or a rigid attachment.

In a second expression of the preferred embodiment of the invention shown in the figures, the child car seat 10 includes a structural seat back 18, a first hook member 28, and a second hook member 30. The seat back 18 includes a wing back 40 having a front 20 and a back 22 and having opposing first and second side portions 42 and 44 each having an outside surface 46 facing substantially away from each other and each having an inside surface 48 facing substantially toward each other. The first hook member 28 has a first attached portion 50 rigidly attached to the first side portion 42 and has a first spaced-apart portion 52 spaced apart from the outside surface 46 of the first side portion 42. It is noted that “attached” includes monolithically, directly, or indirectly attached. The second hook member 30 is spaced apart from the first hook member 28, has a second attached portion 54 rigidly attached to the first side portion 42, and has a second spaced-apart portion 56 spaced apart from the outside surface 46 of the first side portion 42. The first and second spaced-apart portions 52 and 56 are spaced apart from each other by a first gap 32 which is larger than the thickness of the webbing 16 and which is smaller than the width of the webbing 16. The first and second attached portions 50 and 54 are spaced apart from each other by a separation distance 58 which is larger than the first gap 32. The first hook member 28 and the second attached and spaced-apart portions 54 and 56 of the second hook member 30 together define a sideways-projecting and shoulder-belt-receiving first hook 24 substantially enclosing a first through slot 26 extending substantially from front to back. The webbing 16 is engageable in the first through slot 26.

In one example, the first side portion 42 has a top 60 (i.e., a free end) and a bottom 62 (i.e., an end monolithically, directly, or indirectly attached to the structural seat bottom 64 of the child car seat 10), wherein the first and second attached portions 50 and 54 are rigidly attached to the first side portion 42 proximate the top 60 of the first side portion 42. By “proximate” is meant that the first and second attached portions 50 and 54 are rigidly attached to the first side portion 42 closer to the top 60 than to the bottom 62 of the first side portion 42. In this example, the first hook member 28 is disposed above the second hook member 30, wherein the first spaced-apart portion 52 extends substantially downward from the first attached portion 50, and wherein the second spaced-apart portion 56 extends substantially upward from the second attached portion 54. It is noted that descriptive words such as top, bottom, upward, and downward are to be understood with respect to a child car seat 10 installed for use substantially horizontally in a vehicle 12.

In one design, the second hook member 30 also has an additional spaced-apart portion 66 extending substantially downward from the second attached portion 54 and spaced apart from the outside surface 46 of first side portion 42 of the wing back 40. In this design, the child car seat 10 also includes a third hook member 38 disposed below the second hook member 30, having a third attached portion 68 rigidly attached to the wing back 40, and having a third spaced-apart portion 70 spaced apart from the outside surface 46 of the first side portion 42 of the wing back 40. The additional and third spaced-apart portions 66 and 70 are spaced apart from each other by a second gap which is larger than the thickness of the webbing 16 and which is smaller than the width of the webbing 16. The second and third attached portions 54 and 68 are spaced apart from each other by a separation distance which is larger than the second gap.

Preferably, the third hook member 38 and the second attached portion 54 and the additional spaced-apart portion 66 of the second hook member 30 together define a sideways-projecting and shoulder-belt-receiving second hook 34 substantially enclosing a second through slot 36 extending substantially from front to back, wherein the webbing 16 is engageable in the second through slot 36. In one construction, the wing back 40, the first hook member 28, the second hook member 30, and the third hook member 38 together define a monolithic structure. In one choice of materials, the monolithic structure consists essentially of plastic, such as polypropylene. In another construction, not shown, the first second, and third hook members are separate components or a component assembly attached (such as by being bolted) to the seat back. In one example, the third attached portion 68 is rigidly attached to the first side portion 42 proximate the top 60 of the first side portion 42. In this example, the third hook member 38 is disposed below the second hook member 30.

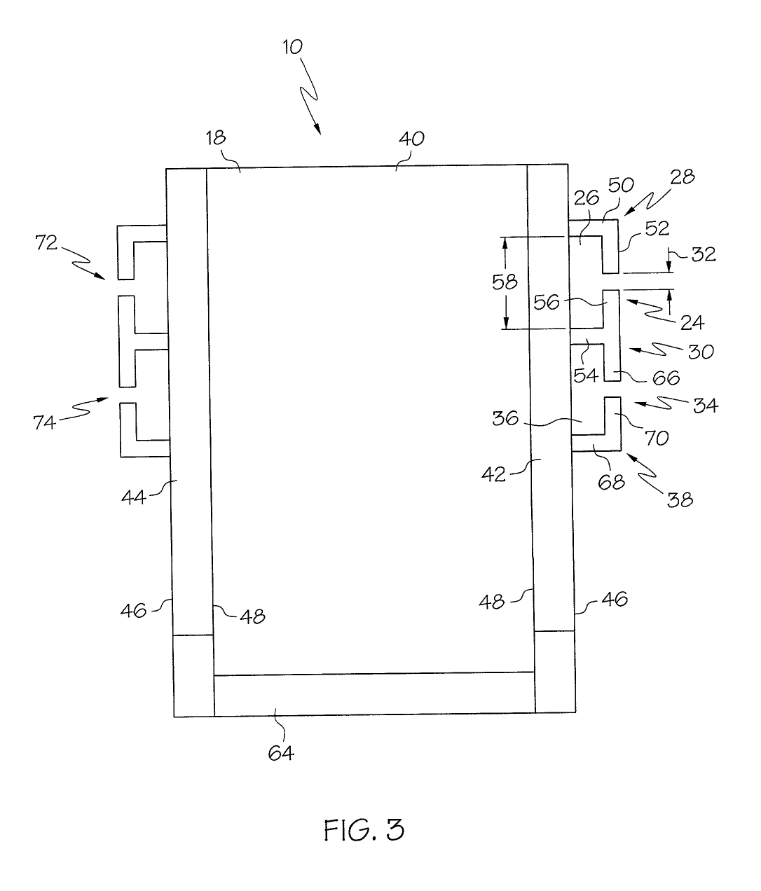

As seen in FIGS. 1 and 3, the child car seat 10 of the preferred embodiment of the invention shown in the figures also includes two shoulder-belt-receiving hooks 72 and 74 attached to the second side portion 44 of the wing back 40. This allows the child car seat 10 to receive a vehicle shoulder belt from either side of the child car seat. The child car seat of the second expression of the preferred embodiment of the invention shown in the figures is not limited to having two hooks on a side portion of the wing back, and additional hooks may be added, as can be appreciated by the artisan.

In operation, as best seen in FIG. 2, the child car seat 10 would be placed on the vehicle seat bottom 76 against the vehicle seat back 78. Then, the child (omitted from FIG. 2 for clarity) would get into, or be placed into, the child car seat 10. The vehicle lap belt (omitted from the FIG. 2 for clarity) would be placed around the lap of the child and its buckle secured to the vehicle. The vehicle shoulder belt 14 would have a length of its webbing 16 extracted, and a section of the webbing 16 would be sideways (i.e., edgewise) inserted through the first gap 32 (between the first and second spaced-apart portions 52 and 56) and into the first through slot 26. Then, preferably the flexible webbing 16 would be placed substantially flat against the outside surface 46 of the first side portion 42. Before or after the webbing 16 is placed in the first slot 26, the vehicle shoulder belt 14 would be placed around the child, and the shoulder belt buckle (omitted from FIG. 2 for clarity) secured to the vehicle. Removal of the child and the child car seat 10 would be accomplished in reverse order. Typically, the child car seat 10 would be used with a previously mentioned (but not shown) cushion pad, wherein the first and second hooks 24 and 34 would protrude above the padding.

The child car seat 10 of the preferred embodiment of the invention shown in the figures may also be equipped with a separate child harness (not shown) to secure the child to the car seat and be equipped with an attachment mechanism or mechanisms (not shown) allowing the vehicle seat belts (the vehicle lap belt and/or the vehicle shoulder belt) to be used only to secure the child car seat to the vehicle. It is noted that without such child harness and attachment mechanism(s), the child car seat 10 is sometimes called a child booster seat. As previously mentioned, the terminology “child car seat” includes, without limitation, “child booster seat”.

Several benefits and advantages are derived from the invention. The design of the child car seat of the invention allows the vehicle shoulder belt to be positioned and retained in a hook which is attached to the seat back providing a more secure attachment than those prior art designs which attach the hook to the cushion pad. The design of the child car seat of the invention provides a hook substantially enclosing a through slot extending substantially from front to back which provides a shorter and more natural path for the webbing than do those prior art hook designs which have slots providing a sideways path for the webbing. The front-to-back slot of the invention allows the webbing to more naturally bend over the child's body instead of having the webbing being bent by the hook as is the case with the sideways slot design of the prior art. Having the hook and the seat back define a monolithic structure reduces manufacturing time and costs.. It is noted that the cushion pad would be cut to surround the hook as it protrudes from the seat back (e.g., wing back). It is further noted that the child car seat of the invention allows for multiple hooks so that the vehicle shoulder belt can be correctly positioned as the child grows.

The foregoing description of several expressions of a preferred embodiment of the invention has been presented for purposes of illustration. It is not intended to be exhaustive or to limit the invention to the precise form disclosed, and obviously many modifications and variations are possible in light of the above teaching. It is intended that the scope of the invention be defined by the claims appended hereto.

What is claimed is:

1. A child car seat for a vehicle, wherein the vehicle has a shoulder belt, wherein the shoulder belt includes a webbing having a width and a thickness, and wherein the child car seat comprises:
a) a structural seat back having a front and a back; and
b) a vehicle-shoulder-belt-receiving first hook attached to the seat back, wherein the first hook substantially encloses a first through slot, wherein the first through slot extends substantially from front to back, wherein the first hook includes two hook members which are spaced apart from each other by a first gap, wherein the first gap is larger than the thickness of the webbing, and wherein the webbing is engageable in the first through slot.

2. The child car seat of claim 1, wherein the first gap is smaller than the width of the webbing.

3. The child car seat of claim 1, wherein the seat back and the first hook together define a monolithic structure.

4. The child car seat of claim 3, wherein the monolithic structure consists essentially of plastic.

5. The child car seat of claim 1, also including a vehicle-shoulder-belt-receiving second hook attached to the seat back below the first hook, wherein the second hook substantially encloses a second through slot, wherein the second through slot extends substantially from front to back, wherein the second hook includes two hook members which are spaced apart from each other by a second gap, wherein the second gap is larger than the thickness of the webbing, and wherein the webbing is engageable in the second through slot.

6. The child car seat of claim 5, wherein the first and second gaps each are smaller than the width of the webbing.

7. The child car seat of claim 5, wherein the seat back, the first hook, and the second hook together define a monolithic structure.

8. The child car seat of claim 7, wherein the monolithic structure consists essentially of plastic.

9. A child car seat for a vehicle, wherein the vehicle has a shoulder belt, wherein the shoulder belt includes a webbing having a width and a thickness, and wherein the child car seat comprises:
a) a structural seat back including a wing back having a front and a back and having opposing first and second side portions each having an outside surface facing substantially away from each other and each having an inside surface facing substantially toward each other;
b) a first hook member having a first attached portion rigidly attached to the first side portion and having a first spaced-apart portion spaced apart from the outside surface of the first side portion; and
c) a second hook member spaced apart from the first hook member, having a second attached portion rigidly attached to the first side portion, and having a second spaced-apart portion spaced apart from the outside surface of the first side portion, wherein the first and second spaced-apart portions are spaced apart from each other by a first gap which is larger than the thickness of the webbing and which is smaller than the width of the webbing, wherein the first and second attached portions are spaced apart from each other by a separation distance which is larger than the first gap, wherein the first hook member and the second attached and spaced-apart portions of the second hook member together define a sideways-projecting and shoulder-belt-receiving first hook substantially enclosing a first through slot extending substantially from front to back, and wherein the webbing is engageable in the first through slot.

10. The child car seat of claim 9, wherein the first side portion has a top and a bottom, and wherein the first and second attached portions are rigidly attached to the first side portion proximate the top of the first side portion.

11. The child car seat of claim 10, wherein the first hook member is disposed above the second hook member, wherein the first spaced-apart portion extends substantially downward from the first attached portion, and wherein the second spaced-apart portion extends substantially upward from the second attached portion.

12. The child car seat of claim 11, wherein the second hook member also has an additional spaced-apart portion extending substantially downward from the second attached portion and spaced apart from the outside surface of first side portion of the wing back.

13. The child car seat of claim 12, also including a third hook member disposed below the second hook member, having a third attached portion rigidly attached to the first side portion of the wing back, and having a third spaced-apart portion spaced apart from the outside surface of the first side portion of the wing back, wherein the additional and third spaced-apart portions are spaced apart from each other by a second gap which is larger than the thickness of the webbing and which is smaller than the width of the webbing, and wherein the second and third attached portions are spaced apart from each other by a separation distance which is larger than the second gap.

14. The child car seat of claim 13, wherein the third hook member and the second attached portion and the additional spaced-apart portion of the second hook member together define a sideways-projecting and shoulder-belt-receiving second hook substantially enclosing a second through slot extending substantially from front to back, and wherein the webbing is engageable in the second through slot.

15. The child car seat of claim 14, wherein the wing back, the first hook member, the second hook member, and the third hook member together define a monolithic structure.

16. The child car seat of claim 15, wherein the monolithic structure consists essentially of plastic.

17. The child car seat of claim 16, wherein the third attached portion is rigidly attached to the first side portion proximate the top of the first side portion.

18. The child car seat of claim 17, wherein the third hook member is disposed below the second hook member.
